(19) United States
(12) Patent Application Publication
(10) Pub. No.: US 2006/0096803 A1
(43) Pub. Date: May 11, 2006

(54) Loudspeaker having an outer edge

(76) Inventors: Ian Stanley White, Suffolk (GB); Duncan Boniface, Mansfield (GB)

Correspondence Address: Myers Dawes;Andras & Sherman, 11th Floor, 19900 MacArthur Boulevard, Irvine, CA, 92612, US

(21) Appl. No.: 10/524,900

(22) PCT Filed: Aug. 15, 2003
(86) PCT No.: PCT/GB03/03594

§ 371 Date: Jan. 5, 2006

(30) Foreign Application Priority Data
Aug. 16, 2002 (GB) 0219106.2

(51) Int. Cl. H04R 7/00

(52) U.S. Cl. 181/171; 181/172

(57) ABSTRACT

A loudspeaker, particularly for use as a guitar loudspeaker, has an undulating lateral extension (18) at the outer edge of the cone-piston (16) and an undulating surround (26) which is bonded to the lateral extension in overlapping relationship thereto, with the overlap zone (D) being laterally outwardly of a peak at the outer edge of the cone piston. The cone (16) is preferably of paper and the surround (26) of cloth material.

This invention relates generally to loudspeakers and is particularly concerned with guitar loudspeakers. The invention is more particularly concerned with the manner in which the loudspeaker cone is connected to the surround which forms the air-tight connection between the outer edge of the cone piston and the speaker chassis.

The surround is an important part of the speaker. It not only forms the air-tight connection to the speaker chassis at the outer edge of the cone piston but, with the rear suspension (or spider) defines the mechanical compliance of the cone. The surround also assists in restoring the excursions of the cone. Guitar speakers need to have cones that are self-loaded, i.e. which do not rely on acoustic enclosures to load the cone. Cone excursion braking is shared between the surround and the rear suspension. The surround also provides the acoustic termination for the speaker. The mechanical losses and geometry of the surround affect the damping of waves travelling up the cone. This in turn strongly influences the performance and the sound which is produced, particularly at mid-range frequencies and higher frequencies.

In guitar speakers, the majority of which have a paper cone and a paper surround, one has an acoustically “poor” termination. This leads to the creation of various break-up modes in the loudspeaker cone. These are essential for musical guitar “tone”, but greatly limit the mechanical excursion of the cone, thus limiting the power rating and frequency response of the speaker.

Loudspeaker designs are also known which have a paper cone and a cloth surround. In these designs the connection between the cone and the surround is at the actual outer edge of the cone piston, thus introducing a discontinuity. With such designs there is also a substantial amount of damping in the surround, which damps out non-linearities and makes it difficult to achieve a lively response. With such designs it is difficult to achieve guitar speaker behaviour.

Loudspeakers in which a flat annular extension of the cone piston overlaps with and is joined to a flat annular portion of a support surround lying outwardly of the piston are shown in U.S. Pat. No.3,997,023, GB-A-2114397 and U.S. Pat. No. 6,095,280.

U.S. Pat. No. 2,490,466 describes a loudspeaker in which a support ring lies beneath and spaced from an outward extension portion of the cone piston. The extension portion and support ring have corrugated portions which are spaced from each other, the extension portion and the ring being joined by respective flat overlapping annular portions.

GB-A-1574855 shows a loudspeaker in which respective rolled edges of a piston cone and an annular support surround overlap and are joined to each other.

It is an object of the present invention to provide a cone/surround combination which enables one to retain the guitar speaker sound signature whilst enabling the achievement of a longer throw, i.e. mechanical excursion, of the cone.

The achievement of a longer throw avoids cone damage at higher power inputs, and it also enables one to achieve more bass capability.

Broadly in accordance with the present invention this is achieved by a loudspeaker comprising a cone which has a lateral extension at the outer edge of the cone piston, and a surround which is bonded to the lateral extension in overlapping relationship thereto, with the overlap zone being laterally outwardly of the outer edge of the cone piston, the lateral extension of the cone comprising an undulating portion, and the surround having a correspondingly undulating portion overlapping therewith.

Preferably, the zone of overlap extends over at least the distance from a peak to a trough of the respective undulations.

Advantageously, the undulating portions are generally sinusoidal and the zone of overlap extends over a length which represents at least about 180° of the waveform.

In a preferred arrangement, the lateral extension of the cone falls from a first peak at the outer edge of the cone piston to form a trough and then rises to form a further peak at which it terminates, the surround overlapping the extension from the second peak to the said trough.

The invention also provides a loudspeaker comprising a cone which has a lateral extension at the outer edge of the cone piston, and a surround which is bonded to the lateral extension, the lateral extension and the surround having respective undulating portions, the undulating portion of the lateral extension extending outwardly from a peak at the outer edge of the cone piston and being bonded outwardly of the said peak to the undulating portion of the surround.

Preferably, the undulating portions of the extension and the surround are bonded over an overlap zone lying outwardly of the said peak.

Advantageously, a free portion of the extension extending outwardly from the said peak is not bonded to the surround, the free portion preferably extending outwardly from the said peak at least to a trough to which the extension falls from the said peak.

Preferably, in loudspeakers according to the invention, the depth of the undulations in the lateral extension of the cone is greater than the depth of the undulations in the surround.

Conveniently, the cone is of paper and the surround is of cloth.

By positioning the join between the surround and the cone in the active, i.e. moving, part of the surround, one avoids the discontinuity of conventional designs and enhances the creation of natural cone modes.

This configuration also braces the edge of the main cone and affords gradual restoring of the cone from its excursions. This enables one to use thin-section cones, enhancing the behaviour of the speaker as a guitar speaker.

In order that the invention may be more fully understood, one presently preferred embodiment of cone/surround assembly in accordance with the invention will now be described by way of example and with reference to the accompanying drawing, in which:

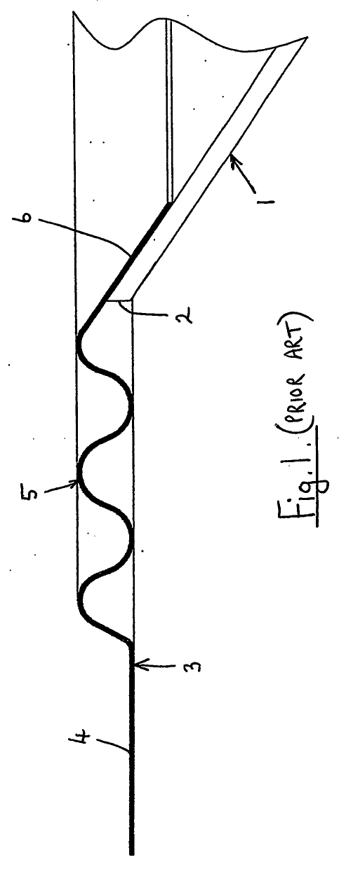

FIG. 1 shows a known cone and surround assembly for a public address (PA) loudspeaker;

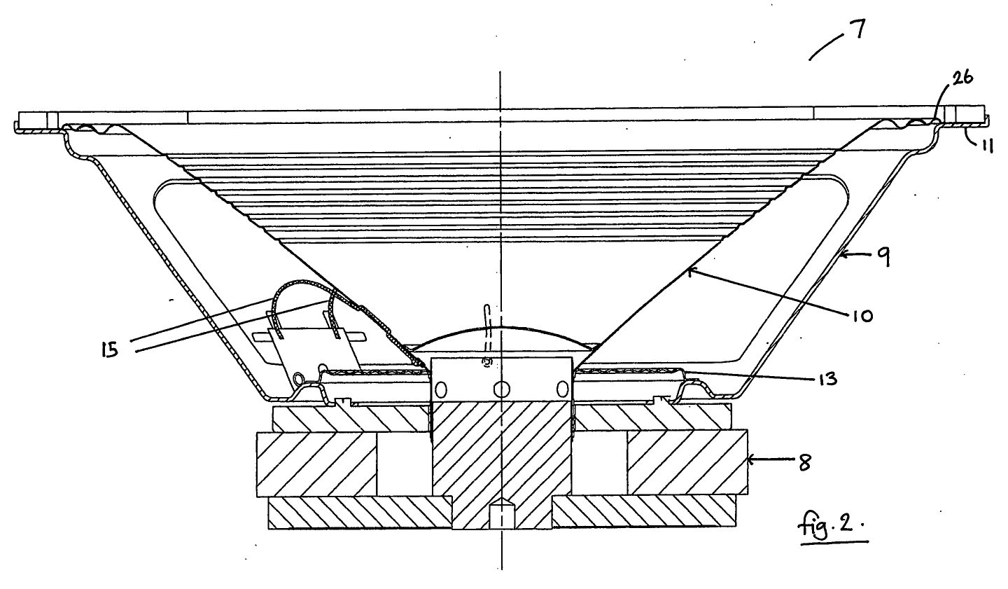

FIG. 2 is a transverse section through a guitar loudspeaker embodying the invention;

FIG. 3 is a partial section through the cone/surround assembly of the loudspeaker of FIG. 2;

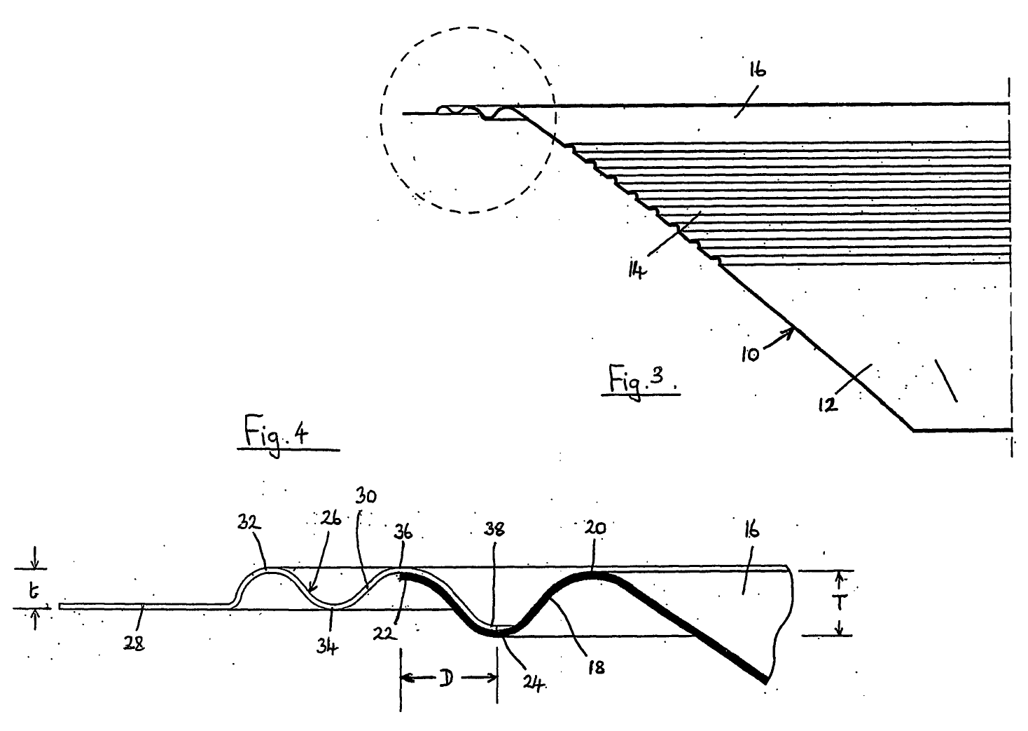

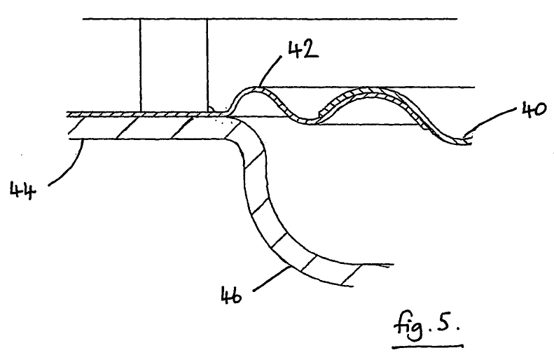

FIG. 4 is a view of a detail of FIG. 3, on an enlarged scale; and

FIG. 5 is a view of a detail of an alternative loudspeaker embodying the invention.

Referring first to FIG. 1, this shows a conventional paper cone and cloth surround assembly for a PA loudspeaker. The paper cone 1 is outwardly tapering and terminates at the outer edge of the cone piston in a surface 2. A surround 3 of cloth material comprises a flat outer portion 4, an undulating portion 5, and a downwardly and inwardly directed flap 6 which overlies the outer end portion of the cone 1 on its inside face. Thus, the zone of overlap between cone 1 and surround 3 is within the body of the cone.

FIG. 2 shows a complete guitar loudspeaker generally at 7, comprising a substantially cylindrical base 8 containing a magnet, connected to a generally conical chassis 9. The chassis 9 terminates in an annular rim 11.

A paper cone 10 of substantially conical shape is connected to the base 8 by an annular suspension member 13. The cone 10 extends from the base 8 and is connected to the annular rim 11 by an annular surround 26. The connection of the cone 10 to the surround 26 is discussed in more detail below. Flexible electrical connectors 15 are attached to a coil which is operatively connected to the cone 10.

In FIG. 3 there is shown a partial section through the core/surround assembly shown in FIG. 2. Here, it can be seen that the paper cone 10 has a smoothly tapering inner portion 12, a ribbed or undulating intermediate portion 14 and a smoothly tapering outer portion 16. The outer edge of the cone piston at the margin of portion 16 is not trimmed off but extends laterally outwards, as shown most clearly in FIG. 4, to provide a lateral extension 18 of the cone. This lateral extension 18 has an undulating or waveform configuration of generally sinusoidal shape. This defines a first peak 20 at the outer edge of the cone piston, a second peak 22 and an intermediate trough 24. The outward termination of the paper cone is at the second peak 22. The height of the waveform from peak 20 to trough 24 is indicated at T. The surround which is indicated generally at 26, is of cloth material. It comprises a flat outer portion 28 and an undulating or waveform portion 30 of generally sinusoidal shape. From the outer portion 28 the surround rises to a first peak 32, falls to a first trough 34, rises to a second peak 36, and then descends to a second trough 38 which coincides with the trough 24 of the cone. The second peak 36 of the surround coincides with the outer end 22 of the cone. The peak to trough height of the surround is indicated as ¢t”. The cone wave height T is approximately twice the surround wave height “t”.

It will be appreciated from the drawing that there is now a zone of overlap between the cone and the surround which is radially outwardly of the outer edge of the cone piston, and here the two elements of the assembly are bonded, for example by gluing. The length of overlap, considered radially, is indicated at D. The bonded overlap is over a length which represents approximately 180° of the waveform.

It will also be appreciated that there is a free portion (a portion not bonded to the surround 26) of the cone extension 18 extending outwardly from the first peak 20 to the trough 24.

Because of this structure where the overlap is not flat surface-to-surface contact as in FIG. 1 but is an undulating surface-to-surface contact, there is greater capacity for flexing movement and the cone 10 is able to undergo a longer throw without losing the guitar-speaker sound signature. The enabling of a longer throw also avoids cone damage at higher power inputs, as well as the achievement of more bass capability. It should also be noted that the surround comprises a relatively stiff portion provided by the cone extension 18 and extending outwardly to its outer edge at the second peak 24, and a more compliant portion outwardly thereof and provided by the portion of the surround extending outwardly from the peak 36 and which is not supported by the cone extension 18.

A partial transverse view of an alternative speaker of the invention is shown in FIG. 5. Here a part of a loudspeaker is shown which has a substantially similar structure to that discussed above with a chassis 46 having an annular rim 44 supporting a surround 42 which is joined to the outer portion 40 of the loudspeaker cone. However, in this embodiment, the outer portion 40 of the loudspeaker cone overlaps above the surround 42, rather than being below the surround, as shown in the embodiment illustrated in FIG. 4.

The construction according to the invention also enables safe bass-reflex alignment for further shaping of low-frequency capability. The assembly enhances bass clarity without compromising the mid- and high-tone response. Because the overlapping zone D is in what is an active, i.e. moving, part of the assembly, one avoids the discontinuity which one has in conventional designs and this enhances the creation of natural cone modes. The outer edge of the main cone 10 is also braced by this configuration, and one has a gradual restoring of the cone excursions. The assembly could be said to be “bi-compliant” or have variable compliance. This allows the use of thin cross-section materials for the cone, which enables one to retain the guitar-speaker behaviour. Also, because there is less damping in the surround with this assembly, the acoustic response is more “live” because non-linearities are not damped out.

In the field of guitar loudspeakers there is an increasing requirement for speakers which function well at low frequencies and with high power inputs. The cone/surround assembly of the present invention addresses this market. It also lends itself to different playing styles, whether this be for example de-tuning, 7-string guitar, heavy metal sound, etc. The invention. also has applications to bass speakers and to PA and general loudspeakers.

The present invention may be embodied in other specific forms without departing from the spirit or essential attributes thereof and, accordingly, reference should be made to the appended claims, rather than to the foregoing specification, as indicating the scope of the invention.

1. A loudspeaker comprising a cone which has a lateral extension at the outer edge of the cone piston, and a surround which is bonded to the lateral extension in overlapping relationship thereto, with the overlap zone being laterally outwardly of the outer edge of the cone piston, the lateral extension of the cone comprising an undulating portion, and the surround having a correspondingly undulating portion overlapping therewith.

2. A loudspeaker according to claim 1, in which the zone of overlap extends over at least the distance from a peak to a trough of the respective undulations.

3. A loudspeaker according to claim 2, in which the undulating portions are generally sinusoidal and the zone of overlap extends over a length which represents at least about 1313400° (degrees) of the waveform.

4. A loudspeaker according to claim 2 or 3, in which the lateral extension of the cone falls from a first peak at the outer edge of the cone piston to form a trough and then rises to form a further peak at which it terminates, the surround overlapping the extension from the second peak to the said trough.

5. A loudspeaker comprising a cone which has a lateral extension at the outer edge of the cone piston, and a surround which is bonded to the lateral extension, the lateral extension and the surround having respective undulating portions, the undulating portion of the lateral extension extending outwardly from a peak at the outer edge of the cone piston and being bonded outwardly of the said peak to the undulating portion of the surround.

6. A loudspeaker according to claim 5, in which the undulating portions of the extension and the surround are bonded over an overlap zone lying outwardly of the said peak.

7. A loudspeaker according to claim 5, in which a free portion of the extension extending outwardly from the said peak is not bonded to the surround.

8. A loudspeaker according to claim 7, in which in which the free portion extends outwardly from the said peak at least to a trough to which the extension falls from the said peak.

9-12. (canceled)

13. A loudspeaker according claim 5, in which the depth of the undulations in the lateral extension of the cone is greater than the depth of the undulations in the surround.

14. A loudspeaker according claim 8, in which the depth of the undulations in the lateral extension of the cone is greater than the depth of the undulations in the surround.

15. A loudspeaker according to claim 14, in which the cone is of paper and the surround is of cloth.

16. A loudspeaker according to claim 14, in which the loudspeaker is a guitar loudspeaker.
